(19) United States
(12) Patent Application Publication
(10) Pub. No.: US 2013/0133841 A1
(43) Pub. Date: May 30, 2013

(54) ROLLER BLIND COUPLING

(71) Applicants: Antony Barnes, Stockport (GB); Andrew Greening, Sandbach (GB)

(72) Inventors: Antony Barnes, Stockport (GB); Andrew Greening, Sandbach (GB)

(73) Assignee: LOUVER-LITE LIMITED, Hyde, Cheshire (GB)

(21) Appl. No.: 13/643,009

(22) PCT Filed: Mar. 23, 2011
(86) PCT No.: PCT/GB2011/000410

§ 371 Date: Feb. 11, 2013

(30) Foreign Application Priority Data
Mar. 23, 2010 (GB) 1004796.7

(51) Int. Cl. E06B 9/174

(52) U.S. Cl. CPC E06B 9/174
USPC 160/120; 464/51; 464/73

(57) ABSTRACT

A roller blind coupling (101) for use in coupling a pair of adjacent roller blinds (102, 104) which are angled relative to each other, the coupling (101) including a first splined bush (2) adapted to engage a first roller tube (106), a second splined bush (4) adapted to engage a second roller tube (108) and a flexible shaft (6), wherein the flexible shaft (6) includes a first connector which engages the first splined bush (2) and a second connector (20) which engages the second splined bush (4), whereby the flexible shaft (6) connects the first and second splined (2, 4) bushes and rotation of the first splined bush (2) is transmitted to the second splined bush (4) via the flexible shaft (6).

The present invention relates to a roller blind coupling and in particular to a coupling for connecting a pair of roller blinds mounted adjacent to each other at an angle.

It is known to connect two adjacent blinds which lie in the same plane, i.e. not angled from each other. This is common where the blinds are required to cover a relatively wide window and a single blind is insufficient. It is also known to connect blinds that are mounted adjacent to each other at an angle. However, in such arrangements, the blinds tend to be connected by a relatively complicated gear arrangement.

According to a first aspect, the present invention provides a roller blind coupling for use in connecting a pair of adjacent roller blinds which are angled relative to each other, the coupling including a first end plug adapted to engage a first roller tube, a second end plug adapted to engage a second roller tube and a flexible shaft, wherein the flexible shaft includes a first connector which engages the first end plug and a second connector which engages the second end plug, whereby the flexible shaft connects the first and second end plugs and rotation of the first end plug is transmitted to the second end plug via the flexible shaft.

The use of a flexible shaft to connect the blinds provides a simple connection that is able to operate through a wide range of angles. By avoiding a relatively complicated gear arrangement to couple the blinds, it makes it easier to assemble the blinds and avoids potential problems with the gears becoming disengaged. It also makes the coupling cheaper to produce.

For the avoidance of doubt, the term “angled” is used herein to denote an angle which is less than 180°. Typically, the angle is greater than or equal to 90°, for example 90° to 160°, 90° to 140° or 90° to 120°.

In certain embodiments of the invention as described herein, the or each end plug is a splined bush. Splined bushes are well known in the roller blind art and are the end plugs that are inserted into each end of a roller tube. The splines engage inwardly projecting ribs on the roller tube such that the roller tube and the two bushes rotate together. However, the end plugs may be other than splined bushes, provided that they are fixed relative to their respective roller tube in such a way that relative rotation between the roller tube and the end plug is prevented.

In an embodiment of the invention, the first connector and the first end plug each include complimentary elements of a first rotational lock and the second end plug and the second connector each include complimentary elements of a second rotational lock, whereby the first rotational lock prevents rotation of the first end plug relative to the first connector and the second rotational lock prevents rotation of the second end plug relative to the second connector.

The rotational locks prevent relative rotation between the connectors and the end plugs such that losses in torque from the first end plug are minimised.

Suitably, a part of the connector or the end plug is inserted into a part of the other one of the two components. Thus, one of the connector and end plug may include a drive shaft and the other may include a body which defines a respective bore which is adapted to receive the drive shaft. In an embodiment of the invention, the first and second connectors each include a respective drive shaft and the first and second end plugs each include a body which defines a bore into which at least a part of the respective drive shaft is inserted in use.

An arrangement where a part of one component is inserted into a corresponding bore of a second component provides an efficient and mechanically simple method of connecting together the two components.

In the embodiment described immediately above, it is possible to include one element of a rotational lock on the drive shaft and a second element of the rotational lock on the body which defines the bore. For example, the drive shaft may include one or more flats (i.e. flattened portions of an otherwise circular cross-sectioned shaft), it may be square or hexagonal (or have a cross-section other than circular), or it may include splines or teeth. Such rotational lock elements would cooperate with complimentary lock elements formed in the body which defines the bore. Thus, the bore may include one or more flats, it may have a square or hexagonal cross-section or it may include longitudinal channels.

In a further embodiment of the invention, the first and second drive shafts each include one or more flats which are arranged to engage corresponding flats formed in the body which defines the bores.

The flexible shaft of the invention is such that it can be urged out of a linear configuration, but is still capable of transmitting a rotational force (torque) that is imparted to it. In other words, it may be bent into a non-linear configuration, yet retain sufficient torsional stiffness that it is capable of transmitting torque in that configuration.

Such shafts may include an elongate flexible section formed from a polymer, such as rubber, or may be formed from one or more windings of a wire (herein, the term “wire” is used herein to refer to elongate filaments, including fibres), or a combination of both. In embodiments where the flexible shaft includes one or more windings of a wire, the wire may be formed from metal, fibre glass, polymeric fibres or carbon. In addition, the or each wire may be formed from a number of filaments, which may be the same or different. Where more than one winding is present, the windings may be formed from different wires.

The windings typically form a helical arrangement. In certain embodiments, where the flexible shaft includes two or more windings, the helices may be arranged to have opposite lays, in other words, one of the windings may have a right hand lay and another of the windings may have a left hand lay.

In an embodiment of the invention, the flexible shaft includes an elongate polymeric core and one or more wire windings about the core. Additionally or alternatively, the flexible shaft may include longitudinal wire filaments, which run lengthwise along the wire. When present, these may provide additional support and torsional strength to the flexible shaft.

The coupling may include one or more mounting brackets to support the coupling in use. Typically, the coupling includes a first mounting bracket adapted to support the first connector and a second mounting bracket adapted to support the second connector.

The mounting brackets may also function as mounting brackets for adjacent ends of the two neighbouring blinds. Thus, one end of the first blind roller tube may be supported by the first mounting bracket and one end of the second blind roller tube may be supported by the second mounting bracket. In other words, the first connector and first mounting bracket bears the weight of one end of the first blind and the second connector and second mounting bracket bears the weight of one end of the second blind.

The first and second connectors suitably rotate freely within their respective mounting brackets. In order to facilitate this free rotation, the first and second brackets may each include a support portion which defines therein an aperture which is configured to receive therethrough a portion of the respective first or second connector. In an embodiment of the invention, the aperture is configured to receive therethrough the drive shaft of the respective connector, such that the drive shaft is rotatably coupled within the mounting bracket.

In a further embodiment of the invention, the shaft of each connector is formed from a polymeric material and the respective mounting bracket includes a bush made from a polymeric material. It is advantageous to form the drive shaft from a polymeric material. However, the mounting bracket is typically formed from metal. The polymeric bush, which surrounds the aperture defined by the support portion of the bracket, reduces wear on the drive shaft that may otherwise be caused by the rotation of the polymeric shaft within the metal bracket.

In a yet further embodiment of the invention, there is provided a roller blind coupling as defined anywhere above, wherein the coupling further includes an adjuster which is adapted to adjust one blind relative to the other. Thus, the adjuster is capable of rotating the second end plug relative to the first end plug.

In arrangements in which there are two adjacent blinds that are operated simultaneously from a single control unit, it is desired to have the blind fabrics aligned. However, it is often difficult to install blinds such that the fabrics of adjacent blinds are precisely aligned. This is because the nature of roller blinds leads to play between various components, which can result in the blind fabrics being mis-aligned. The inclusion of an adjuster makes it easier for a blind installer to achieve the desired effect, namely alignment of the blind fabrics. In addition, should the blind fabrics become mis-aligned in use or after prolonged use, the adjuster can be used to correct the situation and re-align the blind fabrics.

In an embodiment of the invention, the adjuster forms part of the second connector and includes a first adjuster part connected in use to the flexible shaft and a second adjuster part which is connected in use to the second drive shaft, wherein the second part of the adjuster is capable of rotating relative to the first part of the adjuster.

When the blind is in normal use, both parts of the adjuster will rotate together in response to rotation of the flexible shaft. However, if it is desired to align or re-align the blind fabrics, the adjuster permits drive shaft of the second connector to be rotated relative to the flexible shaft. Rotation of the second drive shaft causes a corresponding rotation of the second end plug and consequently the second roller tube. Accordingly, the second roller tube is rotated relative to first roller tube and the blind fabric of the second blind can be adjusted relative to the blind fabric of the first blind.

In an embodiment of the invention, the adjuster includes a worm drive arrangement. This has the advantage that it can be used to drive the second end plug when desired, but the second end plug is not capable of driving the adjuster.

One way of forming the adjuster is to include a housing within which sits a worm drive arrangement. Thus, the first part of the adjuster includes the housing, and the second part of the adjuster includes the worm gear (which may also be referred to as a worm wheel). The housing may include a captive worm rotatably coupled thereto such that the worm can rotate about its longitudinal axis, but is prevented from being displaced relative to the housing. The worm gear typically is meshed with the worm such that rotation of the worm results in a corresponding rotation of the worm gear.

The housing may include a worm gear support, about which the worm gear rotates when driven by the worm.

According to a second aspect of the invention, there is provided a kit for mounting a pair of roller blinds adjacent to each other at an angle, the kit including a first roller tube, a second roller tube, a control end for the first roller tube, an idle end for the second roller tube and a roller blind coupling as defined anywhere hereinabove.

A third aspect of the invention provides a roller blind assembly, including a first and second roller blind tube, adapted to be mounted adjacent to each other at an angle and each carrying a respective roller blind fabric, a control end connected to the distal end of the first roller blind tube, an idle end connected to the distal end of the second roller blind tube, and a roller blind coupling as defined anywhere hereinabove which connects the adjacent proximal ends of the first and second blind tubes.

In the third aspect, the term “proximal” denotes the end which is adjacent the other blind and the term “distal” denotes the end opposite to the proximal end. Thus, the proximal ends are the ends that are closest together in use and the distal ends are furthest apart in use.

The skilled person will appreciate that the features specified above in connection with embodiments of the invention may be combined with each other and any of the aspects of the invention as defined. Thus, the present invention includes within its scope an aspect of the invention combined with two or more of the features described anywhere herein as optional features. All such combinations of features described herein are considered to be made available to the skilled person.

An embodiment of the invention will now be described, by way of example only, with reference to the accompanying drawings in which:

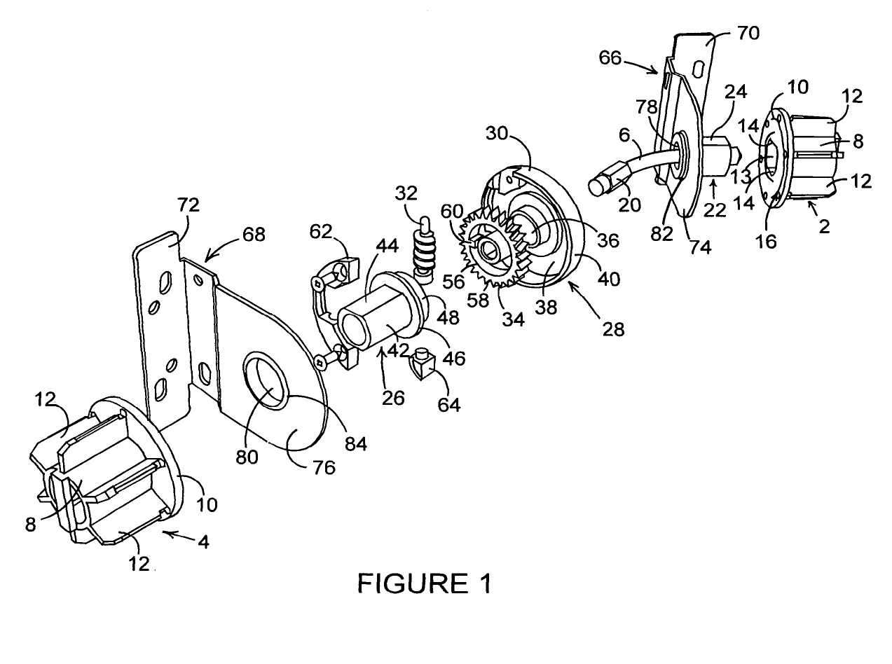

FIG. 1 is an exploded view of the components of a coupling according to the invention;

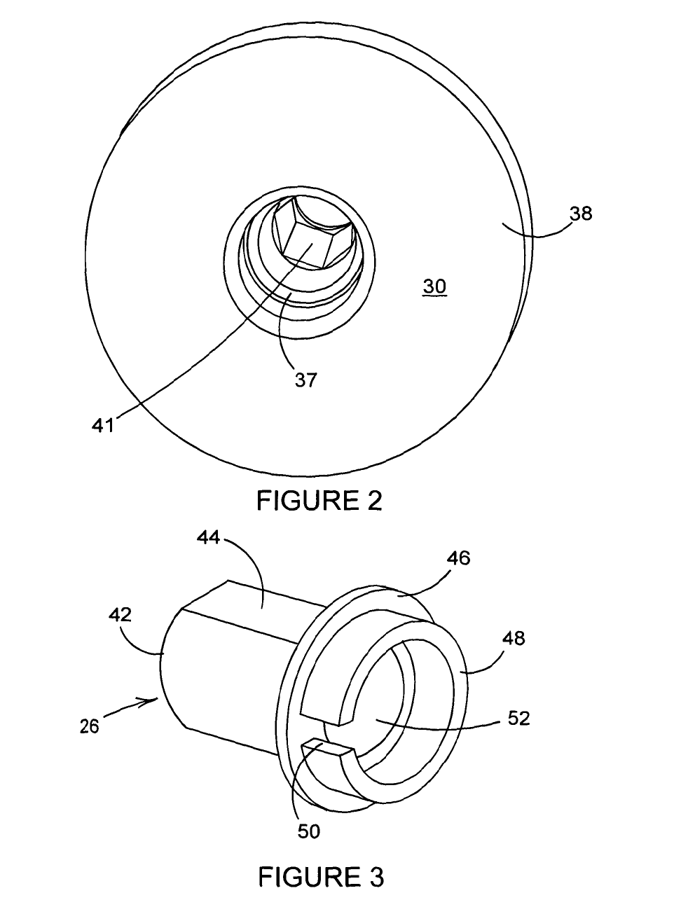

FIG. 2 is a perspective view of the adjuster housing shown in FIG. 1;

FIG. 3 is a perspective view of the second connector drive shaft; and

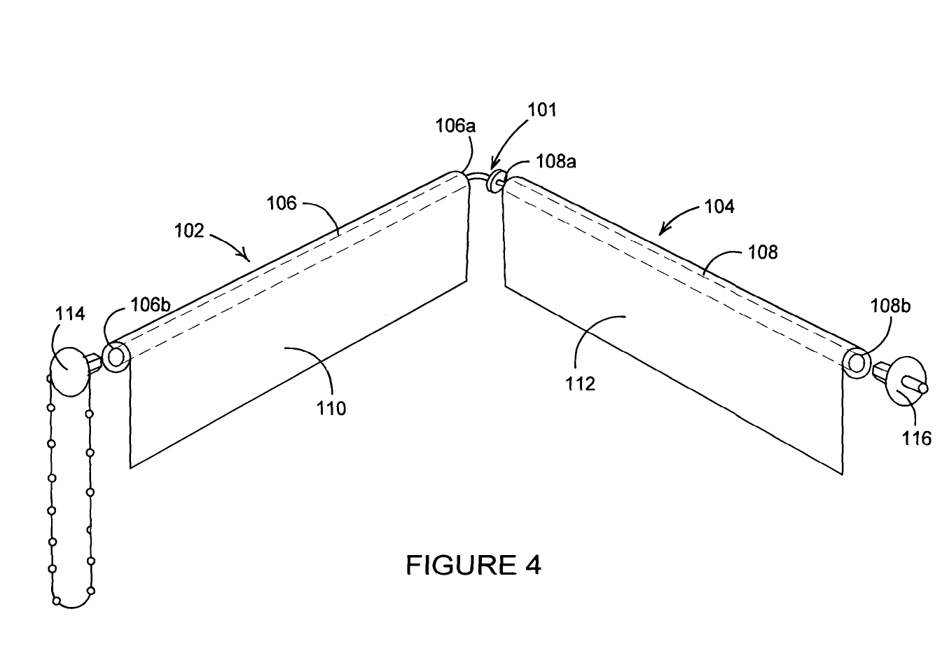

FIG. 4 is a schematic representation of a pair of blinds coupled together with the coupling shown in FIG. 1.

For the avoidance of doubt, the skilled person will appreciate that in this specification, the terms “up”, “down”, “front”, “rear”, “upper”, “lower”, “width”, “above”, “below”, etc. refer to the orientation of the components of the invention when installed for normal use as shown in the Figures.

An embodiment of the invention is shown in FIG. 1. The roller blind coupling includes a first roller blind end plug in the form of a first splined bush 2, a second roller blind end plug in the form of a second splined bush 4 and a flexible shaft 6.

The first and second splined bushes 2, 4 each include a cylindrical body 8, a flange 10 at one end of the body and a plurality of circumferentially spaced splines 12 projecting radially from the body 8. The splines 12 extend along substantially the entire axial length of the body 8.

The body 8 of the first and second splined bushes 2, 4 defines an aperture 13. The aperture 13 has a cross-sectional shape which includes a pair of opposed flats 14 which are joined by curved portions 16 of the body 8.

The flexible shaft 6 includes a first drive connector (not shown) located at one end of the shaft 6 and a second drive connector 20 located at the other end of the shaft 6. The first and second drive connectors 20 have a hexagonal cross-sectional shape.

Connected to the first drive connector is a first drive shaft 22. The first drive shaft includes a body 24 which defines an external shape which is complimentary to that of the aperture 13 of the first splined bush 2 and is adapted to be located within the aperture 13 such that the respective flats defined by the drive shaft body 24 engage the corresponding flats defined by the splined bush body 8.

The body 24 of the first drive shaft further defines an aperture (not shown) which has a hexagonal cross-section and is configured to receive therein the first drive connector of the flexible shaft 6.

The second drive connector 20 of the flexible shaft 6 connects to a second drive shaft 26 via an adjuster 28.

The adjuster 28 includes a housing 30, a worm 32 and a worm gear 34. The housing 30 comprises a support shaft 36, a back plate 38 and an axially projecting rim 40. The support shaft 36 defines an aperture 37 therein, which is shown in more detail in FIG. 2 A distal portion 41 (i.e. furthest from the back plate 38) of the aperture 37 is provided with a hexagonal cross-section which is configured to receive therein and cooperate with the hexagonal drive connector 20 of the flexible shaft 6.

According to this arrangement, the housing 30 of the adjuster 28 is rotationally fixed with respect to the flexible shaft 6

The second drive shaft 26 includes a body which is substantially identical to the body of the first drive shaft 22. Thus, it includes a body 42 which defines an external shape which is complimentary to that of an aperture (not shown) of the second splined bush 4 and is adapted to be located within the aperture such that respective flats 44 defined by the drive shaft body 42 engage the corresponding flats defined by the body 8 of the second splined bush 4. However, instead of an aperture with a hexagonal cross-section, the drive shaft body defines therein an aperture 52 having a circular cross-section (see FIG. 3).

The second drive shaft 26 further includes a flange 46 located at one end of the body 42 and an annular projection 48 extending from the flange away from the body 42. This is best seen in FIG. 3. The annular projection 48 includes a notch 50 defined in the circumference thereof.

The worm gear 34 includes a substantially annular body 56 and a plurality of teeth 58 projecting radially outwardly from the body 56. A single tooth 60 projects radially inwardly from the body 56. The worm gear body 56 is located about the periphery of the annular projection 48 of the second drive shaft 26 such that the tooth 60 is located within the notch 50. In this way, rotation of the worm gear 34 results in corresponding rotation of the second drive shaft 26.

The second drive shaft 26 located on the support shaft 36, i.e. the support shaft 36 is located within the aperture 52, and the annular projection 48 is sandwiched between the support shaft 36 and the body 56 of the worm gear 34.

The teeth 58 of the worm gear 34 are meshed with a captive worm 32. The worm 34 is prevented from displacement relative to the housing 30 by a restraining plate 62. The restraining plate 62 is fixed to the base plate 38 of the housing 30 and defines bearings which permit rotation of the worm about its longitudinal axis. Such an arrangement is well known in the art and will not be described in more detail herein.

Access to the drive element of the captive worm 32 (in this case a hexagonal drive element adapted to be driven by a hexagonal key) is controlled by a lock element 64, which forms a friction fit in the drive element of the captive worm 32.

The first and second drive shafts 22, 26 are supported by corresponding first and second mounting brackets 66, 68. Each of the mounting brackets independently may be secured to a vertical or horizontal surface via a mounting portion 70, 72 and they include a respective support portion 74, 76 which defines an aperture 78, 80 around which is located a corresponding polymeric bush 82, 84.

Each of the first and second drive shafts 22, 26 are located within their respective aperture 78, 80 and the polymeric bush 82, 84 acts as a bearing for the drive shaft 22, 26.

In normal use of the arrangement described in the above embodiment, rotation of a first roller blind tube (not shown) causes rotation of the first splined bush 2. This results in a corresponding rotation of the flexible shaft 6 via the interaction of the aperture 13 defined by the splined bush body 8 with the first drive shaft 22 and the first drive shaft connector with the aperture defined by the first drive shaft body. Rotation of the flexible shaft 6 results in rotation of the adjuster housing 30 via interaction of the second connector 20 with the hexagonal portion 41 of the aperture 37 defined by the support shaft 36. As the captive worm 32 is not being rotated, it effectively prevents the worm gear 34 from rotating relative to the housing 30, so the rotation of the housing 30 causes corresponding rotation of the worm gear 34. The worm gear 34 is rotationally fixed to the second drive shaft 26 via the engagement of the tooth 60 within the notch 50, such that the second drive shaft 26 is driven to rotate by the rotation of the worm gear 34. This transmission of torque continues to the second splined bush 4 via interaction of the second drive shaft 26 with the aperture defined by the second splined bush body 8.

Accordingly, when the captive worm 32 is not driven to rotate, rotation of the first splined bush 2 results in a corresponding rotation of the second splined bush 4 and the two adjacent blinds will move together, with the second roller tube slaved to the first.

However, if it is desired to adjust the length of the blind fabric of the second blind relative to the first blind fabric, then the captive worm 32 is driven to rotate relative to the housing 30, while the housing 30 is maintained stationery. Rotation of the captive worm 32 causes the worm gear 34 to rotate relative to housing 30, which causes the second drive shaft 26 and hence the second splined bush 4 to rotate. As the housing 30, and hence the flexible shaft 6 are stationery, the second blind can be moved relative to the first blind. Thus, the second blind fabric can be raised or lowered relative to the first blind fabric.

FIG. 4 shows a schematic representation of a pair of blinds 102, 104 coupled together by the coupling 101 shown in FIG. 1 and described above, such that the two roller blind 102, 104 are arranged at an angle to each other.

Each of the roller blinds 102, 104 includes a roller blind tube 106, 108 around which is located a roller blind fabric sheet 110, 112.

The roller blind tubes 106, 108 are connected at their respective proximal ends 106a, 108a by the coupling 101 described above with reference to FIGS. 1, 2 and 3. At the distal end 106b of the roller blind tube 106 is provided a control end set 114. The control end set 114 is a standard roller blind control end and includes a splined bush, a drive sprocket, a sprocket support, a wrap spring clutch and an operating chain. Such an arrangement is well known for roller blinds (see, for example U.S. Pat. No. 7,677,293 and U.S. Pat. No. 7,100,668, the contents of which are incorporated herein by reference) and need not be described in detail herein.

At the distal end 108b of the roller tube 108 is provided an idle end set 116. The skilled person appreciates that an idle end set includes a splined bush and a projecting stub axle which is rotationally carried within a bearing formed in a mounting bracket (not shown) to enable the distal end 108b of the roller tube 108 to rotate freely when the proximal end 108a of the roller tube 108 is driven to rotate by the coupling.

1. A roller blind coupling for use in coupling a pair of adjacent roller blinds which are angled relative to each other, the coupling including a first end plug adapted to engage a first roller tube, a second end plug adapted to engage a second roller tube and a flexible shaft, wherein the flexible shaft includes a first connector which engages the first end plug and a second connector which engages the second end plug, whereby the flexible shaft connects the first and second end plugs and rotation of the first end plug is transmitted to the second end plug via the flexible shaft.

2. A roller blind coupling according to claim 1, wherein the first and/or second end plugs comprise a splined bush.

3. A roller blind coupling according to claim 1, wherein the first connector and the first end plug each include complimentary elements of a first rotational lock and the second end plug and the second connector each include complimentary elements of a second rotational lock, whereby the first rotational lock prevents rotation of the first end plug relative to the first connector and the second rotational lock prevents rotation of the second end plug relative to the second connector.

4. A roller blind coupling according to claim 1, wherein the first and second connectors each include a respective drive shaft, and the first and second end plugs each include a body which defines a bore into which at least a part of the respective drive shaft is inserted in use.

5. A roller blind coupling according to claim 4, wherein the first and second drive shafts each include one or more flats which are arranged to engage corresponding flats formed in the body which defines the bores.

6. A roller blind coupling according to claim 1, wherein the flexible shaft includes one or more wire windings whereby the shaft may be bent, but still retain a desired level of torsional stiffness such that it is capable of transmitting torque in a bent configuration.

7. A roller blind coupling according to claim 6, wherein the or each wire is formed from metal, fibre glass, polymeric fibres, carbon or mixtures thereof.

8. A roller blind coupling according to claim 1, wherein the flexible shaft includes an elongate flexible section formed from a polymer.

9. A roller blind coupling according to claim 8, wherein the flexible shaft includes one or more wire windings about the elongate flexible section.

10. A roller blind coupling according to claim 1, wherein the coupling further includes a first mounting bracket adapted to support the first connector and a second mounting bracket adapted to support the second connector.

11. A roller blind coupling according to claim 1, wherein the coupling further includes an adjuster which is capable of rotating the second end plug relative to the first end plug.

12. A roller blind coupling according to claim 11, wherein the adjuster forms part of the second connector and includes a first part connected in use to the flexible shaft and a second part which is connected in use to the second drive shaft, wherein the second part of the adjuster is capable of rotating relative to the first part of the adjuster.

13. A roller blind coupling according to claim 12, wherein the first part of the adjuster includes a housing and the second part of the adjuster includes a worm gear.

14. A kit for mounting a pair of roller blinds adjacent to each other at an angle, the kit including a first roller tube, a second roller tube, a control end for the first roller tube, an idle end for the second roller tube and a roller blind coupling including a first end plug adapted to engage a first roller tube, a second end plug adapted to engage a second roller tube and a flexible shaft, wherein the flexible shaft includes a first connector which engages the first end plug and a second connector which engages the second end plug, whereby the flexible shaft connects the first and second end plugs and rotation of the first end plug is transmitted to the second end plug via the flexible shaft.

15. A roller blind assembly, including a first and second roller blind tube, adapted to be mounted adjacent to each other at an angle and each carrying a respective roller blind fabric, a control end connected to the distal end of the first roller blind tube, an idle end connected to the distal end of the second roller blind tube, and a roller blind coupling including a first end plug adapted to engage a first roller tube, a second end plug adapted to engage a second roller tube and a flexible shaft, wherein the flexible shaft includes a first connector which engages the first end plug and a second connector which engages the second end plug, whereby the flexible shaft connects the first and second end plugs and rotation of the first end plug is transmitted to the second end plug via the flexible shaft, wherein the roller blind coupling connects adjacent proximal ends of the first and second blind tubes.
